(19) United States
(12) Patent Application Publication
(10) Pub. No.: US 2025/0324168 A1
(43) Pub. Date: Oct. 16, 2025

(54) IMAGING ELEMENT AND ELECTRONIC APPARATUS

(71) Applicant: SONY SEMICONDUCTOR SOLUTIONS CORPORATION, KANAGAWA (JP)

(72) Inventors: YUKI YAGISHITA, KANAGAWA (JP); YOSHIO AWATANI, KANAGAWA (JP)

(21) Appl. No.: 18/863,200

(22) PCT Filed: Mar. 27, 2023
(86) PCT No.: PCT/JP2023/012162

§ 371 Date: Nov. 5, 2024

(30) Foreign Application Priority Data
May 12, 2022 (JP) 2022-078837

(51) Int. Cl. H04N 25/60; H04N 25/78

(52) U.S. Cl. CPC H04N 25/60; H04N 25/78

(57) ABSTRACT

An imaging element according to the present technology includes a pixel that outputs a pixel signal, a reference signal generation unit that generates a reference signal having an inclined waveform, an analog-digital conversion circuit that includes a comparator that compares the pixel signal with the reference signal and performs analog-digital conversion on the pixel signal, and a noise correction circuit that corrects noise of a pixel power supply by superimposing the noise on the reference signal. The noise correction circuit includes a first correction circuit that generates a first correction signal for correcting a relatively low frequency band with respect to noise of the pixel power supply, and a second correction circuit that generates a second correction signal for correcting a relatively high frequency band with respect to noise of the pixel power supply, the second correction signal having an output polarity different from that of the first correction signal.

### TECHNICAL FIELD

The present technology relates to an imaging element. Specifically, the present technology relates to an imaging element including an analog-digital conversion circuit including a comparator, and an electronic apparatus including the imaging element.

### BACKGROUND ART

In an imaging element such as a CMOS image sensor, due to characteristics of a pixel, there is a parasitic capacitance between nodes in the pixel or noise of a pixel power supply propagated to a signal line via a signal amplification unit. When the noise of the pixel power supply is input to the comparator of the analog-digital conversion circuit through the signal line, a conversion error occurs in the analog-digital conversion, which causes deterioration in image quality of the captured image.

In order to remove the noise of the pixel power supply, the imaging element provided with the analog-digital conversion circuit including the comparator is provided with a noise correction circuit that cancels the noise of the pixel power supply by inverting the polarity of the power supply noise and superimposing the power supply noise on a reference signal RAMP as a correction

### CITATION LIST

### Patent Document

Patent Document 1: WO 2020/054629 A

### SUMMARY OF THE INVENTION

### Problems to be Solved by the Invention

In the related art described above, for example, when considering a case where the power supply of the reference signal generation unit that generates the reference signal RAMP is connected to the same power supply as the pixel, in a relatively high frequency band, there is a case where the component in which the noise of the pixel power supply propagates to the comparator via the reference signal generation unit becomes dominant. In a case where the phase of the propagation component of the noise of the pixel power supply through the reference signal generation unit is inverted with respect to the noise, the phase becomes the same as the output phase of the noise correction circuit. Therefore, the noise correction circuit acts in a direction of enhancing the noise of the pixel power supply, and there is a possibility that the power supply noise cannot be canceled.

The present technology has been made in view of such a situation, and an object thereof is to enable noise of a pixel power supply to be corrected even in a relatively high frequency band.

### Solutions to Problems

The present technology has been made to solve the above-described problems, and a first aspect of the present technology is an imaging element including: a pixel that outputs a pixel signal according to incident light; a reference signal generation unit that generates a reference signal having an inclined waveform, the inclined waveform linearly changing with a predetermined inclination as time elapses; an analog-digital conversion circuit that includes a comparator, the comparator comparing the pixel signal with the reference signal, and performs analog-digital conversion on the pixel signal; and a noise correction circuit that corrects noise of a pixel power supply, the pixel power supply supplying power to the pixel by superimposing the noise on the reference signal. The noise correction circuit includes: a first correction circuit that generates a first correction signal for correcting a relatively low frequency band with respect to noise of the pixel power supply; and a second correction circuit that generates a second correction signal, the second correction signal being different in output polarity from the first correction signal and correcting a relatively high frequency band for noise of the pixel power supply. Therefore, it is possible to correct, preferably cancel, the noise of the pixel power supply not only in the relatively low frequency band but also in the relatively high frequency band, and thus, it is possible to obtain a captured image with higher image quality.

Furthermore, in the first aspect, for the first correction circuit, a reverse-phase signal for the variation component of the pixel power supply may be generated as the first correction signal, and for the second correction circuit, an in-phase signal for the variation component of the pixel power supply may be generated as the second correction signal. Therefore, it is possible to correct, preferably cancel, the noise of the pixel power supply not only in the relatively low frequency band but also in the relatively high frequency band.

Furthermore, in the first aspect, the first correction circuit and the second correction circuit each may have a function of adjusting frequency characteristics of the first correction signal and the second correction signal. Therefore, in the first correction circuit, the frequency characteristics can be adjusted in accordance with the characteristics of the noise component of the pixel power supply via the pixel, and in the second correction circuit, the frequency characteristics can be adjusted in accordance with the characteristics of the noise component of the pixel power supply via the reference signal generation unit.

Furthermore, in the first aspect, the noise correction circuit may correct noise of a power supply that supplies power to the comparator. Therefore, it is possible to prevent an error caused by the power supply noise of the comparator from occurring in the comparison and determination result of the comparator.

Furthermore, in the first aspect, a pair of signals having phases inverted from each other may be generated as the first correction signal for the first correction circuit, and a pair of signals having phases inverted from each other may be generated as the second correction signal for the second correction circuit. Therefore, even if the circuit configuration of the pixel or the reference signal generation unit tends to be complicated, it is possible to easily cope with the influence of the complicated noise.

Furthermore, in the first aspect, the first correction circuit and the second correction circuit each may include a pair of correction circuits that generates a pair of signals having phases inverted from each other. Therefore, even if the circuit configuration of the pixel or the reference signal generation unit tends to be complicated, it is possible to easily cope with the influence of the complicated noise by the pair of correction circuits.

Furthermore, in the first aspect, for each of the first correction circuit and the second correction circuit, a pair of signals having phases inverted from each other may be generated by on/off control of a switch element. Therefore, even if the circuit configuration of the pixel and the reference signal generation unit tends to be complicated, it is possible to easily cope with the influence of the complicated noise only by the on/off control of the switch element in one circuit (each circuit of the first correction circuit and the second correction circuit).

Furthermore, a second aspect of the present technology is an electronic apparatus including an imaging element. The imaging element includes: a pixel that outputs a pixel signal according to incident light; a reference signal generation unit that generates a reference signal having an inclined waveform, the inclined waveform linearly changing with a predetermined inclination as time elapses; an analog-digital conversion circuit that includes a comparator, the comparator comparing the pixel signal with the reference signal, and performs analog-digital conversion on the pixel signal; and a noise correction circuit that corrects noise of a pixel power supply, the pixel power supply supplying power to the pixel by superimposing the noise on the reference signal. The noise correction circuit includes: a first correction circuit that outputs a first correction signal for correcting a relatively low frequency band with respect to noise of the pixel power supply; and a second correction circuit that outputs a second correction signal, the second correction signal being different in output polarity from the first correction signal and correcting a relatively high frequency band for noise of the pixel power supply. Therefore, it is possible to correct, preferably cancel, the noise of the pixel power supply not only in the relatively low frequency band but also in the relatively high frequency band, and thus, it is possible to obtain a captured image with higher image quality.

### BRIEF DESCRIPTION OF DRAWINGS

FIG. 1 is a system configuration diagram illustrating a configuration example of an imaging element according to an embodiment of the present technology.

FIG. 2 is a circuit diagram illustrating a circuit example of a pixel (pixel circuit) of the imaging element according to the embodiment of the present technology.

FIG. 3 is a block diagram illustrating a basic configuration example of an analog-digital conversion unit of the imaging element according to the embodiment of the present technology.

FIG. 4 is a circuit diagram illustrating a configuration example of a noise correction circuit according to Example 1 in the embodiment of the present technology.

FIG. 5 is a diagram schematically illustrating an effect of correction by the noise correction circuit according to Example 1 in the embodiment of the present technology.

FIG. 6 is a circuit diagram illustrating a circuit example of a low-frequency correction circuit in the noise correction circuit according to Example 1.

FIG. 7 is a circuit diagram illustrating a circuit example of a high-frequency correction circuit in the noise correction circuit according to Example 1.

FIG. 8 is a circuit diagram illustrating a configuration example of a noise correction circuit according to Example 2 in the embodiment of the present technology.

FIG. 9 is a circuit diagram illustrating a configuration example of a noise correction circuit according to Example 3 in the embodiment of the present technology.

FIG. 10 is a circuit diagram illustrating a circuit example of a low-frequency correction circuit (in-phase) in a noise correction circuit according to Example 3.

FIG. 11 is a circuit diagram illustrating a circuit example of a high-frequency correction circuit (reverse phase) in the noise correction circuit according to Example 3.

FIG. 12 is a circuit diagram illustrating a circuit example of a low-frequency correction circuit in a noise correction circuit according to Example 4.

FIG. 13 is a circuit diagram illustrating a circuit example of a high-frequency correction circuit in a noise correction circuit according to Example4.

FIG. 14 is a circuit diagram illustrating a circuit configuration example of a comparator according to Circuit Example 1.

FIG. 15 is a circuit diagram illustrating a circuit configuration example of a comparator according to Circuit Example 2.

FIG. 16 is a block diagram illustrating a configuration example of an imaging device which is an example of an electronic apparatus to which the present technology is applied.

FIG. 17 is a diagram illustrating an example of fields to which the embodiments of the present technology are applied.

FIG. 18 is a block diagram depicting an example of schematic configuration of a vehicle control system.

FIG. 19 is an explanatory diagram illustrating an example of an installation position of an imaging unit.

### MODE FOR CARRYING OUT THE INVENTION

Hereinafter, modes for carrying out the present technology (hereinafter referred to as embodiments) will be described. The description will be given in the following order.
1. Imaging element of Present Technology
   1-1. Configuration Example of Imaging Element
   1-2. Circuit Example of Pixel
   1-3. Configuration Example of Analog-Digital Conversion Unit
2. Noise Correction Circuit in Embodiment of Present Technology
   2-1. Example 1
   2-2. Example 2
   2-3. Example 3
   2-4. Example 4
3. Another Circuit Example of Comparator in Analog-Digital Conversion Unit
   3-1. Circuit Example 1
   3-2. Circuit Example 2
4. Modifications
   5. Application Example to Electronic Apparatus
6. Usage Example of Imaging Element
7. Configuration that can be taken by Present Technology
   1. Imaging Element of Present Technology One example of an imaging element of the present technology is a complementary metal oxide semiconductor (CMOS) image sensor, which is a type of an X-Y address system imaging element. The CMOS image sensor is an imaging element fabricated by applying or partially using a CMOS process.

### 1-1. Configuration Example of Imaging Element

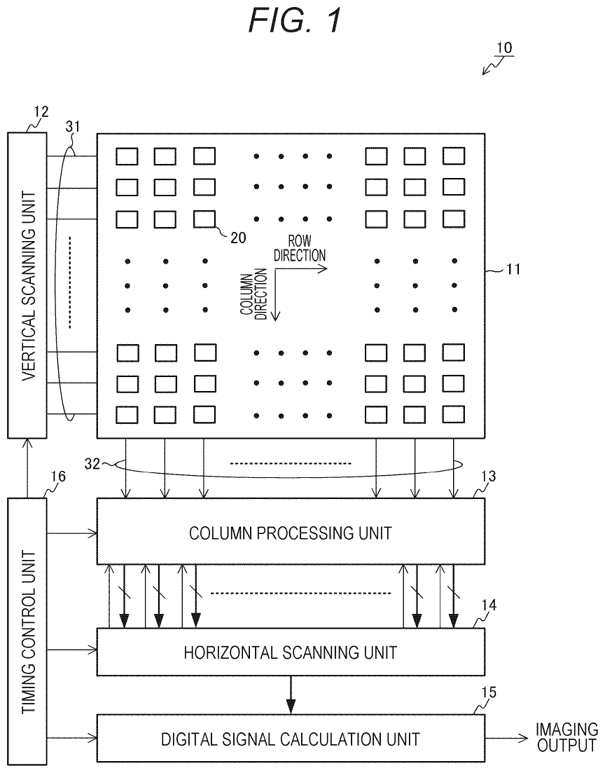

FIG. 1 is a block diagram illustrating a configuration example of an imaging element according to an embodiment of the present technology. An imaging element 10 includes a pixel array unit 11 and a peripheral circuit unit of the pixel array unit 11. The peripheral circuit unit of the pixel array unit 11 includes, for example, a vertical scanning unit 12, a column processing unit 13, a horizontal scanning unit 14, a digital signal calculation unit 15, a timing control unit 16, and the like.

The pixel array unit 11 has pixels (pixel circuits) 20 which are two-dimensionally arranged in a row direction and a column direction, that is, in a matrix. Each of the pixels 20 includes a photoelectric conversion unit (photoelectric conversion element). Here, the row direction refers to a direction in which the pixels 20 in a pixel row are arrayed, and the column direction refers to a direction in which the pixels 20 in a pixel column are arrayed. Each of the pixels 20 performs photoelectric conversion to generate and accumulate photoelectric charge corresponding to an amount of incident light. In the example illustrated in FIG. 1, the pixel array of the pixel array unit 11 is a pixel array of m rows and n columns (m and n are integers). That is, m represents the number of rows, and n represents the number of columns.

In the pixel array unit 11, a pixel control line 31 is wired for each pixel row with respect to a pixel array of m rows and n columns. Furthermore, a signal line 32 is wired for each pixel 20.

When reading a signal from the pixel 20, the pixel control line 31 transmits a drive signal output from the vertical scanning unit 12 in units of pixel rows. In FIG. 1, the pixel control line 31 is illustrated as one wire, but the number thereof is not limited to one. One end of the pixel control line 31 is connected to an output terminal corresponding to each row of the vertical scanning unit 12. The signal line 32 transmits a signal read from the pixel 20 to the column processing unit 13.

Hereinafter, each component of the peripheral circuit unit of the pixel array unit 11, that is, the vertical scanning unit 12, the column processing unit 13, the horizontal scanning unit 14, the digital signal calculation unit 15, and the timing control unit 16 will be described.

The vertical scanning unit 12 includes a shift register, an address decoder, and the like, and controls scanning for the pixel row and an address of the pixel row on the basis of a timing control signal supplied from the timing control unit 16 when selecting each pixel 20 of the pixel array unit 11. Although a specific configuration of the vertical scanning unit 12 is not illustrated, the vertical scanning unit 12 generally includes two scanning systems of a read scanning system and a sweep scanning system.

The column processing unit 13 reads a signal from each pixel 20 of the pixel array unit 11 on the basis of the timing control signal supplied from the timing control unit 16, performs analog-digital conversion processing, correlated double sampling processing (CDS processing), and the like, and outputs the signal as a pixel signal. Details of the analog-digital conversion unit which is one of the functional units of the column processing unit 13 will be described later.

The horizontal scanning unit 14 includes a shift register, an address decoder, and the like, and selectively scans each pixel 20 of the pixel array unit 11 in order on the basis of a timing control signal supplied from the timing control unit 16. By the selective scanning by the horizontal scanning unit 14, pixel signals converted into digital signals for each unit circuit in the column processing unit 13 are sequentially output to the digital signal calculation unit 15.

The digital signal calculation unit 15 performs predetermined digital calculation on the pixel signals sequentially output from the horizontal scanning unit 14 on the basis of the timing control signal supplied from the timing control unit 16, and sets the calculation result as imaging output.

The timing control unit 16 generates various signals such as a timing signal, a clock signal, and a control signal on the basis of a synchronization signal provided from the outside. Then, the timing control unit 16 performs drive control of the vertical scanning unit 12, the column processing unit 13, the horizontal scanning unit 14, the digital signal calculation unit 15, and the like on the basis of the generated signals.

### 1-2. Circuit Example of Pixel

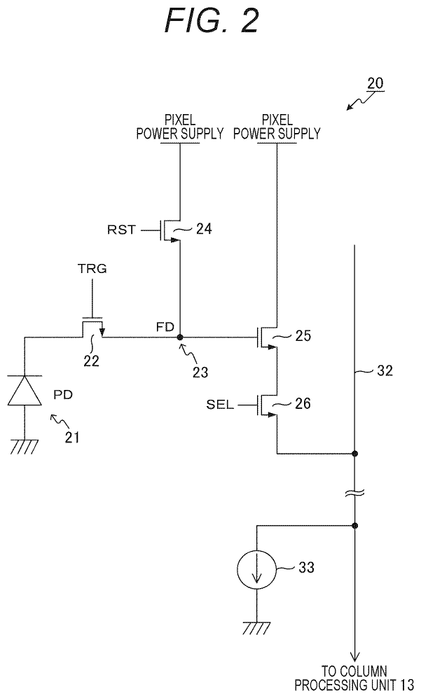

FIG. 2 is a circuit diagram illustrating a circuit example of the pixel (pixel circuit) 20 of the imaging element 10 according to the embodiment of the present technology. Each pixel 20 of the pixel array unit 11 includes a photoelectric conversion unit 21, a charge transfer unit 22, a charge-voltage conversion unit 23, a charge resetting unit 24, a signal amplification unit 25, and a pixel selection unit 26. A predetermined voltage is supplied from a power supply (pixel power supply) of the pixel 20 to the charge resetting unit 24 and the signal amplification unit 25.

Here, as the charge transfer unit 22, the charge resetting unit 24, the signal amplification unit 25, and the pixel selection unit 26, for example, N-channel MOS field-effect transistors can be used. However, a combination of conductivity types of the four MOS transistors 22, 24, 25, and 26 herein exemplified is merely an example, and the combination is not limited thereto.

For the pixel 20, as the pixel control line 31 described above, a plurality of pixel control lines is wired in common to the respective pixels 20 of the same pixel row. Each of the plurality of pixel control lines is connected to the corresponding one of the output terminals corresponding to each pixel row of the vertical scanning unit 12 in units of pixel rows. The vertical scanning unit 12 appropriately outputs a transfer signal TRG, a reset signal RST, and a selection signal SEL to the plurality of pixel control lines.

Note that a constant current source 33 is connected to one end of the signal line 32 wired for each pixel column of the pixel array unit 11.

The photoelectric conversion units 21 are PN-junction photodiodes (PDs). Each of the photodiodes has an anode electrode connected to a low-potential-side power supply (for example, ground), and generates an electric charge corresponding to an amount of incident light and accumulates therein the generated electric charge.

The charge transfer unit 22 transfers the charge accumulated in the photoelectric conversion unit 21 to the charge-voltage conversion unit 23 in accordance with the transfer signal TRG provided from the vertical scanning unit 12. Specifically, a transfer signal TRG that is active at a high level is supplied from the vertical scanning unit 12 to the gate electrode of the transistor constituting the charge transfer unit 22. Then, the transistor constituting the charge transfer unit 22 becomes conductive, and transfers the charge accumulated in the photoelectric conversion unit 21 to the charge-voltage conversion unit 23.

The charge-voltage conversion unit 23 is capacitance of a floating diffusion (FD) region formed between a drain region of the transistor constituting the charge transfer unit 22 and a source region of the transistor constituting the charge resetting unit 24. The charge-voltage conversion unit 23 converts the charge transferred from the photoelectric conversion unit 21 by the charge transfer unit 22 into a voltage.

The charge resetting unit 24 resets the charge accumulated in the charge-voltage conversion unit 23 in accordance with the reset signal RST provided from the vertical scanning unit 12. Specifically, the reset signal RST that is active at a high level is provided from the vertical scanning unit 12 to the gate electrode of the transistor constituting the charge resetting unit 24. Then, the transistor constituting the charge resetting unit 24 becomes conductive, and resets the charge accumulated in the charge-voltage conversion unit 23.

The signal amplification unit 25 amplifies the voltage converted by the charge-voltage conversion unit 23 and outputs a pixel signal at a level corresponding to the charge accumulated in the charge-voltage conversion unit 23. The gate electrode of the transistor constituting the signal amplification unit 25 is connected to the charge-voltage conversion unit 23, and the drain electrode is connected to the node of a power supply voltage Vdd. Then, the transistor constituting the signal amplification unit 25 serves as an input unit of a circuit that reads out charges obtained by photoelectric conversion in the photoelectric conversion unit 21, that is, a source follower circuit. That is, in the transistor constituting the signal amplification unit 25, the source electrode is connected to the signal line 32 via the pixel selection unit 26, thereby constituting a source follower circuit with the constant current source 33 connected to one end of the signal line 32.

The pixel selection unit 26 selects any pixel 20 in the pixel array unit 11 under selective scanning by the vertical scanning unit 12. The transistor constituting the pixel selection unit 26 is connected between the source electrode of the transistor constituting the signal amplification unit 25 and the signal line 32, and the selection signal SEL in which a high level is active is supplied from the vertical scanning unit 12 to the gate electrode thereof. Then, when the selection signal SEL becomes a high level, the transistor constituting the pixel selection unit 26 is brought into a conductive state. Therefore, the pixel 20 enters a selected state. When the pixel 20 enters the selected state, a signal output from the signal amplification unit 25 is read out to the column processing unit 13 via the signal line 32.

From the pixel 20 of the above circuit configuration example, a reset signal (so-called P-phase signal), which is a reset level at the time of resetting the charge-voltage conversion unit 23 by the charge resetting unit 24, and a data signal (so-called D-phase signal), which is a signal level corresponding to the charge based on the photoelectric conversion in the photoelectric conversion unit 21, are sequentially output. That is, the pixel signal output from the pixel 20 includes a reset signal at the time of resetting and a data signal at the time of photoelectric conversion in the photoelectric conversion unit 21.

### 1-3. Basic Configuration Example of Analog-Digital Conversion Unit

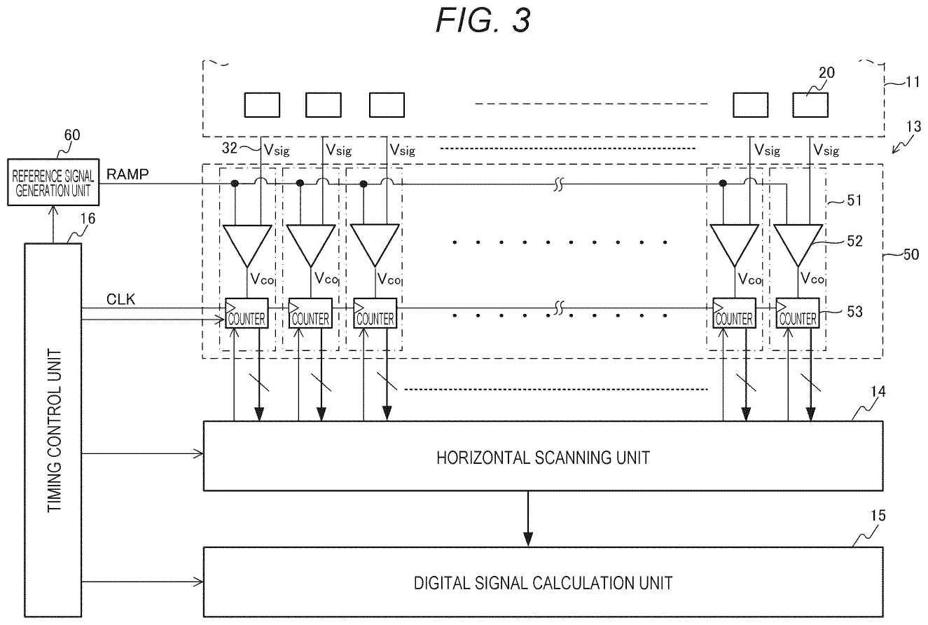

Next, a basic configuration example of an analog-digital conversion unit which is one of functional units of the column processing unit 13 will be described. FIG. 3 is a block diagram illustrating a basic configuration example of an analog-digital conversion unit of the imaging element 10 according to the embodiment of the present technology. FIG. 3 also illustrates a peripheral circuit unit of the analog-digital conversion unit.

An analog-digital conversion unit 50, which is one of the functional units of the column processing unit 13, acquires an analog pixel signal supplied from each pixel 20 of the pixel array unit 11 through the signal line 32 on the basis of the timing control signal supplied from the timing control unit 16, and sequentially converts the analog pixel signal into a digital pixel signal.

The analog-digital conversion unit 50 includes a plurality of analog-digital conversion circuits 51 provided corresponding to the respective pixels 20 of the pixel array unit 11. In the imaging element 10 according to the embodiment of the present technology, for example, a so-called single-slope analog-digital conversion circuit, which is an example of a reference signal comparison type analog-digital conversion circuit, is used as the analog-digital conversion circuit 51.

In the analog-digital conversion unit 50 using the single-slope analog-digital conversion circuit, a reference signal of an inclined waveform (for example, monotonically decreasing) that linearly changes with time with a predetermined inclination, that is, a reference signal RAMP of a ramp wave is used as a standard signal at the time of analog-digital conversion. The reference signal RAMP of the ramp wave is generated in a reference signal generation unit 60 on the basis of the timing control signal supplied from the timing control unit 16. The reference signal generation unit 60 can be configured using, for example, a digital-analog conversion circuit.

The analog-digital conversion circuit 51 includes a comparator 52 and a column counter 53, and is provided for each pixel 20 of the pixel array unit 11.

The comparator 52 uses the analog pixel signal Vsig supplied from each pixel 20 of the pixel array unit 11 through the signal line 32 as a comparison input, and uses the reference signal RAMP of the ramp wave generated by the reference signal generation unit 60 as a reference input to compare both signals. Then, for example, at the timing when the reference signal RAMP of the ramp wave exceeds the voltage value of the analog pixel signal Vsig, a signal (comparison result) Vco notifying that the reference signal RAMP exceeds the voltage value of the analog pixel signal Vsig is output. Therefore, the comparator 52 outputs, as a comparison result Vco, a pulse signal having a pulse width corresponding to the signal level of the analog pixel signal Vsig, specifically, the magnitude of the signal level.

A clock signal CLK is supplied from the timing control unit 16 to the column counter 53 at the same timing as the supply start timing of the reference signal RAMP of the ramp wave to the comparator 52. The column counter 53 performs a counting operation in synchronization with the clock signal CLK to measure the period of the pulse width of the output pulse of the comparator 52, that is, the period from the start of the comparison operation to the end of the comparison operation. The count result (count value) of the column counter 53 is supplied to the horizontal scanning unit 14 as a digital value obtained by digitizing the analog pixel signal Vsig.

As described above, the analog-digital conversion unit 50 including the single-slope analog-digital conversion circuit 51 compares the analog pixel signal Vsig output from the pixel 20 with the reference signal RAMP of the ramp wave generated by the reference signal generation unit 60. Then, a digital value can be obtained from the time information from the start of the comparison to the timing (that is, the timing at which the output of the comparator 52 is inverted) at which the magnitude relationship between the analog pixel signal Vsig and the reference signal RAMP of the ramp wave changes.

2. Noise Correction Circuit according to Embodiment of Present Technology

In the imaging element 10 such as the CMOS image sensor described above, due to the characteristics of the pixel 20, parasitic capacitance between nodes in the pixel 20 and noise (hereinafter, it may be simply described as power supply noise) of the pixel power supply propagated to the signal line 32 via the signal amplification unit 25 exist. When the noise of the pixel power supply is input to the comparator 52 of the analog-digital conversion circuit 51 through the signal line 32, a conversion error occurs in analog-digital conversion, and an accurate pixel value cannot be obtained, which causes deterioration in image quality of a captured image.

As a technique for removing noise of the pixel power supply, there is known a technique (see, for example, Patent Document 1) of generating a reverse-phase correction signal obtained by inverting a phase with respect to the noise and superimposing the correction signal on the reference signal RAMP. In this related art, for example, in a case where the power supply of the reference signal generation unit 60 is connected to the same pixel power supply as the pixel 20, if the power supply voltage variation removal ratio (PSRR) of the reference signal generation unit 60 is insufficient, there is a possibility that the influence cannot be canceled.

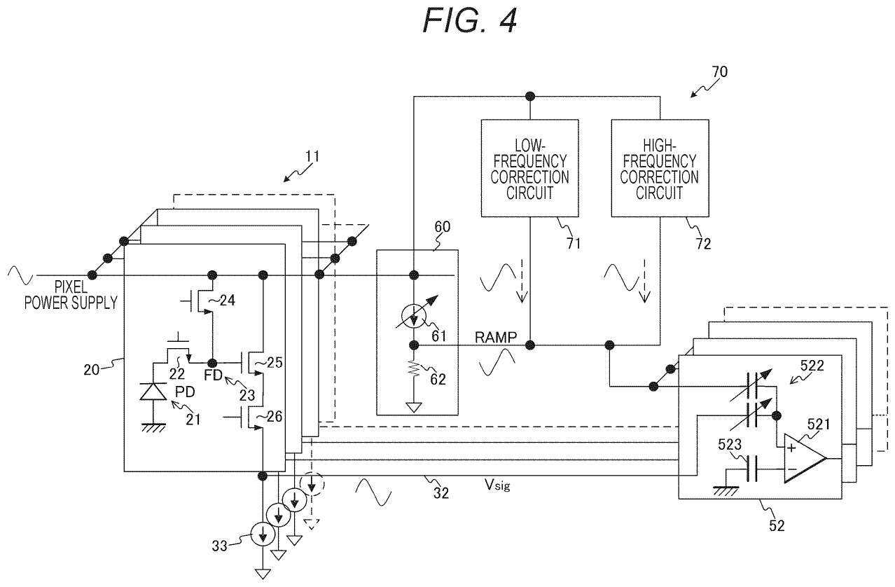

For example, in a relatively low frequency band, when components in which the propagation of the noise of the pixel power supply is transmitted via the circuit of the pixel 20 are dominant, these components can be canceled by the noise correction circuit of the reverse-phase output described above. On the other hand, in a relatively high frequency band, the component in which the noise of the pixel power supply propagates to the comparator 52 via the reference signal generation unit 60 may become dominant. Then, in a case where the phase of the propagation component of the noise of the pixel power supply through the reference signal generation unit 60 is inverted with respect to the noise (see FIG. 4), the phase becomes the same as the output phase of the noise correction circuit. Therefore, the noise correction circuit acts in a direction of enhancing the noise of the pixel power supply, and there is a possibility that the power supply noise cannot be canceled.

Hereinafter, a specific example of a noise correction circuit capable of correcting, preferably canceling, noise of a pixel power supply not only in a relatively low frequency band but also in a relatively high frequency band in the imaging element 20 according to the embodiment of the present technology will be described.

### 2-1. Example 1

Example 1 in the embodiment of the present technology is an example in which two correction circuits of a low-frequency correction circuit and a high-frequency correction circuit are included as a noise correction circuit 70 that removes noise of the pixel power supply. Note that the low-frequency correction circuit is an example of a first correction circuit described in the claims, and the high-frequency correction circuit is an example of a second correction circuit described in the claims.

FIG. 4 is a circuit diagram illustrating a configuration example of the noise correction circuit 70 according to Example 1 in the embodiment of the present technology. FIG. 4 also illustrates a circuit unit related to the noise correction circuit 70, that is, the pixel array unit 11, the reference signal generation unit 60, and the comparator 52.

Example 1 exemplifies a case where a digital-analog conversion circuit (DAC) including, for example, a variable current source 61 and a resistive element 62 connected in series is used as the reference signal generation unit 60. In the reference signal generation unit 60, a current value is controlled by the variable current source 61, and a current of the current value flows through the resistive element 62 to generate a voltage. The voltage generated here is a reference signal RAMP of a ramp wave (inclined waveform) that linearly changes with a predetermined inclination with the lapse of time. The same applies to examples to be described later.

Furthermore, Example 1 exemplifies a case where an ultra-low voltage comparator having a voltage lower than the voltage of the pixel power supply as an operating voltage is used as the comparator 52, for example. The comparator 52 including an ultra-low voltage comparator includes a comparator main body 521, an input capacitance switching unit 522, and a capacitive element 523.

The input capacitance switching unit 522 takes in the analog pixel signal Vsig output from the pixel 20 and the reference signal RAMP of the ramp wave generated by the reference signal generation unit 60, and uses them as a positive-phase (+) input of the comparator main body 521. The capacitive element 523 holds the ground level as a reference voltage, for example, and uses the ground level as a reverse phase (−) input of the comparator main body 521.

As described above, the imaging element 10 according to the embodiment of the present technology using the digital-analog conversion circuit as the reference signal generation unit 60 and the ultra-low voltage comparator as the comparator 52 includes, as the noise correction circuit 70, two correction circuits of a low-frequency correction circuit 71 and a high-frequency correction circuit 72.

The low-frequency correction circuit 71 and the high-frequency correction circuit 72 use the same power supply (pixel power supply) as the pixel 20 as an operation power supply, and output a current according to a variation of the pixel power supply. The output terminals of the low-frequency correction circuit 71 and the high-frequency correction circuit 72 are connected to the output terminal of the reference signal generation unit 60, that is, the output terminal that outputs the reference signal RAMP of the ramp wave. The currents output from the low-frequency correction circuit 71 and the high-frequency correction circuit 72 flow into the resistive element 62 of the reference signal generation unit 60 to be converted into voltage signals.

The low-frequency correction circuit 71 generates a first correction signal for correcting a relatively low frequency band with respect to noise of the pixel power supply. Specifically, the low-frequency correction circuit 71 generates, as the first correction signal, a reverse-phase signal to the variation of the pixel power supply. The high-frequency correction circuit 72 generates a second correction signal that has an output polarity different from that of the first correction signal and corrects a relatively high frequency band for noise of the pixel power supply. Specifically, the high-frequency correction circuit 72 generates, as the second correction signal, an in-phase signal with respect to the variation of the pixel power supply.

In a case where the pixel power supply varies, noise of the pixel power supply is input to the comparator 52 via the pixel 20. Specifically, in a relatively low frequency band, a component transmitted via the circuit of the pixel 20 is dominant in propagation of noise of the pixel power supply to the comparator 52. Then, the power supply variation component input to the comparator 52 has the same phase (in-phase) relationship with respect to the noise of the pixel power supply. In order to correct, preferably cancel, the noise of the pixel power supply, it is necessary to input a reverse-phase signal whose phase is inverted with respect to the noise of the pixel power supply to the opposite side of the input side of the pixel signal Vsig in the input capacitance switching unit 522 of the comparator 52 (that is, on the input side of the reference signal RAMP). The reverse-phase signal is generated as the first correction signal by the low-frequency correction circuit 71, and the first correction signal is superimposed on the reference signal RAMP, so that the noise of the pixel power supply in the relatively low frequency band can be corrected, preferably canceled.

Moreover, in a case where the power supply of the reference signal generation unit 60 is connected to the pixel power supply, a power supply noise component may be input to the comparator 52 via the reference signal generation unit 60. Specifically, in a relatively high frequency band, the component in which the noise of the pixel power supply propagates to the comparator 52 via the reference signal generation unit 60 may become dominant.

When considering a case where the noise component of the pixel power supply propagated to the comparator 52 via the reference signal generation unit 60 has a reverse phase inverted for the variation component of the pixel power supply, the noise component and the first correction signal have the same reverse phase, and cannot be canceled. Therefore, in order to correct, preferably cancel, the noise component propagated to the comparator 52 via the reference signal generation unit 60, a correction circuit that outputs a positive-phase signal is required.

Therefore, the noise correction circuit 70 according to Example 1 includes a high-frequency correction circuit 72 in addition to the low-frequency correction circuit 71. Then, the positive-phase signal is generated as the second correction signal by the high-frequency correction circuit 72, and the second correction signal is superimposed on the reference signal RAMP, whereby the noise of the pixel power supply in the relatively high frequency band can be corrected, preferably canceled.

As described above, according to the noise correction circuit 70 according to Example 1, by including the high-frequency correction circuit 72 in addition to the low-frequency correction circuit 71, it is possible to correct, preferably cancel, the noise of the pixel power supply not only in the relatively low frequency band but also in the relatively high frequency band, and thus, it is possible to obtain a captured image with higher image quality.

Specific circuit configurations of the low-frequency correction circuit 71 and the high-frequency correction circuit 72 will be described later in detail.

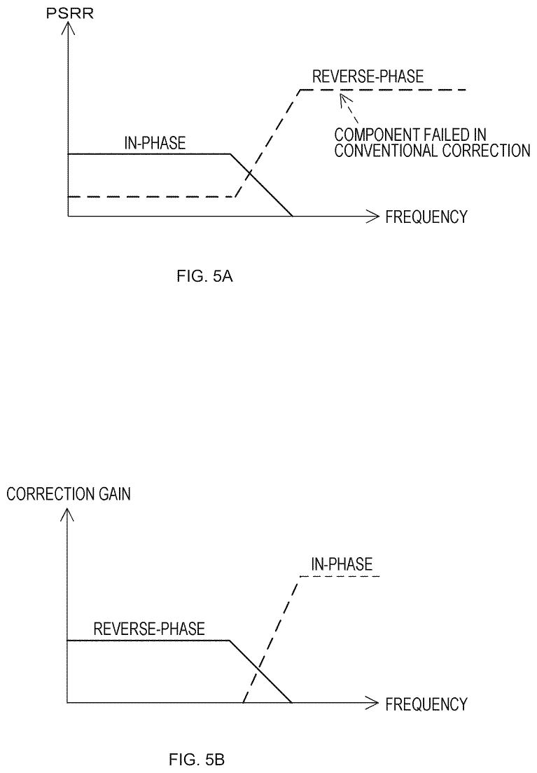

FIG. 5 is a diagram schematically illustrating an effect of correction by the noise correction circuit 70 according to Example 1. a of FIG. 5 illustrates the influence degree of noise of the pixel power supply, specifically, the power supply voltage variation removal ratio (PSRR) with respect to the frequency. b of FIG. 5 illustrates the correction gain with respect to the frequency.

In a relatively low frequency band, a noise component passing through the pixel 20 is dominant as indicated by a solid line in a of FIG. 5. The first correction signal having the reverse phase for the noise component can be generated, and the noise of the pixel power supply in the relatively low frequency band can be corrected, preferably canceled by the low-frequency correction circuit 71 in which the gain and the frequency characteristics are adjusted as indicated by the solid line in b of FIG. 5.

In a relatively high frequency band, as indicated by a broken line in a of FIG. 5, the noise component via the reference signal generation unit 60 is dominant. The in-phase second correction signal can be generated for the noise component, and the noise of the pixel power supply in the relatively high frequency band can be corrected, preferably canceled, by the high-frequency correction circuit 72 in which the gain and the frequency characteristics are adjusted as indicated by a broken line in b of FIG. 5.

### Low-frequency Correction Circuit

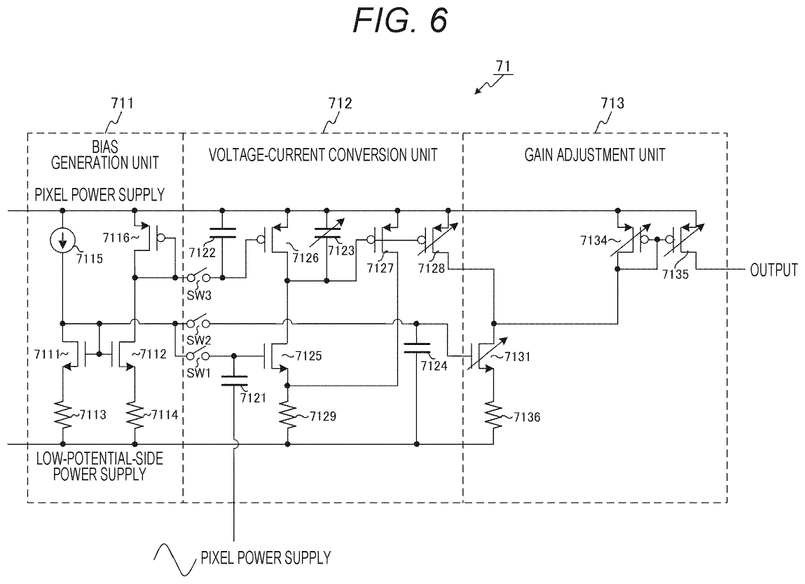

FIG. 6 is a circuit diagram illustrating a circuit example of the low-frequency correction circuit 71 in the noise correction circuit 70 according to Example 1.

As illustrated in FIG. 6, the low-frequency correction circuit 71 includes a bias generation unit 711, a voltage-current conversion unit 712, and a gain adjustment unit 713.

The bias generation unit 711 has a circuit configuration including two nMOS (n-channel MOS) transistors 7111 and 7112, two resistive elements 711371_14, one constant current source 7115, and one pMOS (p-channel MOS) transistor 7116.

A gate electrode of the nMOS transistor 7111 and a gate electrode of the nMOS transistor 7112 are commonly connected, and a gate electrode and a drain electrode of the nMOS transistor 7111 are commonly connected to constitute a current mirror circuit.

The resistive element 711371_14 is connected between each source electrode of the nMOS transistors 7111 and 7112 and a low-potential-side power supply. The constant current source 7115 is connected between the drain electrode of the nMOS transistor 7111 and the pixel power supply. The pMOS transistor 7116 is connected between the drain electrode of the nMOS transistor 7112 and the pixel power supply, and the gate electrode and the drain electrode are connected in common.

The bias generation unit 711 having the above-described configuration is provided to determine the operating points of the MOS transistors in the two functional block units of the voltage-current conversion unit 712 and the gain adjustment unit 713.

The voltage-current conversion unit 712 has a circuit configuration including three switch elements SW1 to SW3, four capacitive elements 7121 to 7124, one nMOS transistor 7125, three pMOS transistors 7126 to 7128, and one resistive element 7129.

One ends of the switch elements SW1 and SW2 are connected to a gate common connection node of the nMOS transistors 7111 and 7112. One end of the switch element SW1 is connected to a gate-drain common connection node of the pMOS transistor 7116.

The pMOS transistor 7126, the nMOS transistor 7125, and the resistive element 7129 are connected in series between the pixel power supply and the low-potential-side power supply. A gate electrode of the pMOS transistor 7126 is connected to the other end of the switch element SW3. The capacitive element 7122 is connected between the pixel power supply and the gate electrode of the pMOS transistor 7126. A gate electrode of the nMOS transistor 7125 is connected to the other end of the switch element SW1. Pixel power is supplied to a gate electrode of the nMOS transistor 7125 via the capacitive element 7121.

The gate electrodes of the pMOS transistors 7127 and 7128 are commonly connected to each other, and are connected to a drain common connection node of the pMOS transistor 7126 and the nMOS transistor 7125. The pMOS transistor 7128 has a variable transistor size. The capacitive element 7123 is a variable capacitive element having a variable capacitance value, and is connected between the pixel power supply and a drain common connection node of the pMOS transistor 7126 and the nMOS transistor 7125. The capacitive element 7124 is connected between the other end of the switch element SW2 and the low-potential-side power supply.

The voltage-current conversion unit 712 having the above-described configuration converts the variation in the voltage of the pixel power supply into a current and outputs the current. In the voltage-current conversion unit 712, the cutoff frequency of the low-frequency correction circuit 71 can be adjusted by adjusting the capacitance value of the capacitive element 7123 including the variable capacitive element. The converted current is supplied to the gain adjustment unit 713.

The gain adjustment unit 713 has a circuit configuration including one nMOS transistor 7131, two pMOS transistors 7134 and 7135, and one resistive element 7136.

The nMOS transistor 7131 has a variable transistor size, and has a gate electrode connected to the other end of the switch element SW2 and a drain electrode connected to the drain electrode of the pMOS transistor 7128. The resistive element 7136 is connected between the source electrode of the nMOS transistor 7131 and the low-potential-side power supply. That is, the nMOS transistor 7131 and the resistive element 7136 are connected in series with each other.

The pMOS transistor 7134 and the pMOS transistor 7135 have variable transistor sizes, and gate electrodes are connected in common, and in the pMOS transistor 7134, a gate electrode and a drain electrode are connected in common, thereby constituting a current mirror circuit. Each source electrode of the pMOS transistors 7134 and 7135 is connected to a pixel power supply. Furthermore, the drain electrode of the pMOS transistor 7134 is connected to the drain electrode of the nMOS transistor 7131.

The drain electrode of the pMOS transistor 7135 serves as an output terminal (that is, the output terminal of the low-frequency correction circuit 71) of the gain adjustment unit 713. Therefore, the first correction signal generated by the low-frequency correction circuit 71 can be derived from the drain electrode of the pMOS transistor 7135.

When the variation of the voltage of the pixel power supply is converted into a current and output from the voltage-current conversion unit 712, the gain adjustment unit 713 having the above-described configuration performs gain adjustment by amplifying or attenuating the current and outputs the current. Amplification or attenuation can be realized by adjusting the current mirror ratio of the current mirror circuit including the pMOS transistors 7134 and 7135.

### High-Frequency Correction Circuit

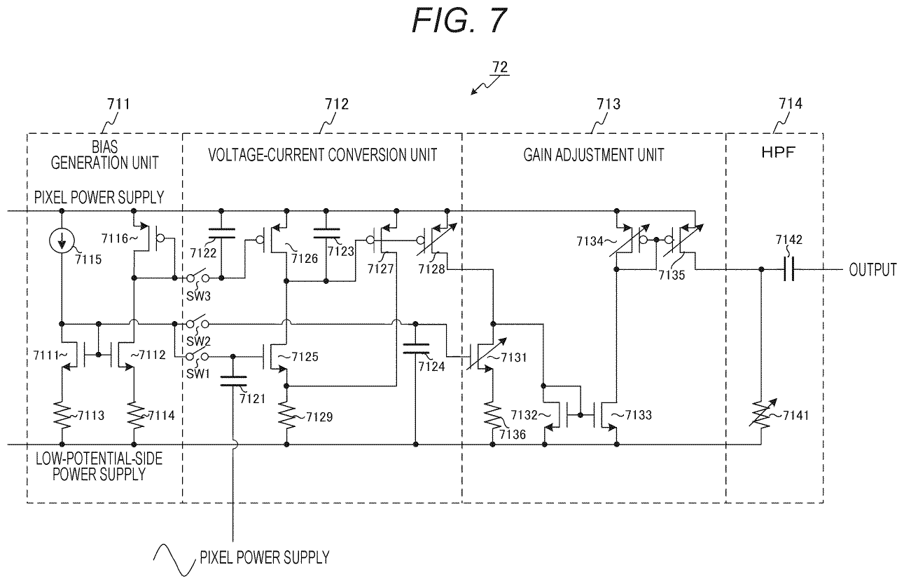

FIG. 7 is a circuit diagram illustrating a circuit example of the high-frequency correction circuit 72 in the noise correction circuit 70 according to Example 1.

As illustrated in FIG. 7, the high-frequency correction circuit 72 includes a high-pass filter (HPF) 714 in addition to the bias generation unit 711, the voltage-current conversion unit 712, and the gain adjustment unit 713 in the low-frequency correction circuit 71. The circuit configurations of the bias generation unit 711 and the voltage-current conversion unit 712 are the same as those of the low-frequency correction circuit 71.

The gain adjustment unit 713 has a circuit configuration including two nMOS transistors 7132 and 7133 in addition to the nMOS transistor 7131, the pMOS transistors 7134 and 7135, and the resistive element 7136. A gate electrode of the nMOS transistor 7132 and a gate electrode of the nMOS transistor 7133 are commonly connected, and a gate electrode and a drain electrode of the nMOS transistor 7132 are commonly connected to constitute a current mirror circuit. Each source electrode of the nMOS transistors 7132 and 7133 is connected to a low-potential-side power supply. The nMOS transistor 7132 is connected in parallel to a series connection circuit of the nMOS transistor 7131 and the resistive element 7136.

The high-pass filter (HPF) 714 has a circuit configuration including a resistive element 7141 and a capacitive element 7142. The resistive element 7141 is a variable resistive element having a variable resistance value, and is connected between the drain electrode of the pMOS transistor 7135 and the low-potential-side power supply. One end of the capacitive element 7142 is connected to the drain electrode of the pMOS transistor 7135. Then, the other end of the capacitive element 7142 serves as an output end (that is, the output terminal of the low-frequency correction circuit 71) of the high-pass filter 714. Therefore, the second correction signal generated by the high-frequency correction circuit 72 can be derived from the other end of the capacitive element 7142.

Each of the low-frequency correction circuit 71 and the high-frequency correction circuit 72 described above has a function of adjusting a gain. This is because adjustment is performed according to the noise propagation characteristic (PSRR: power supply voltage variation removal ratio) of the pixel power supply. For example, when the PSRR is large, the influence of noise propagation increases, and thus, it is necessary to adjust the first correction signal and the second correction signal according to the magnitude of the noise component. In the low-frequency correction circuit 71 illustrated in FIG. 6 and the high-frequency correction circuit 72 illustrated in FIG. 7, the gain adjustment can be performed by adjusting the current mirror ratio of the current mirror circuit including the pMOS transistors 7134 and 7135 of the gain adjustment unit 713.

Furthermore, the low-frequency correction circuit 71 illustrated in FIG. 6 has a function of adjusting frequency characteristics. This adjustment of the frequency characteristics can be performed by adjusting the capacitance value of the capacitive element 7123 including the variable capacitive element. The characteristic of the PSRR changes depending on the frequency, and the noise component via the pixel 20 gradually decreases as viewed from the low frequency side in a region where the frequency is equal to or higher than a certain value. An attenuation characteristic of the first correction signal needs to be adjusted according to the characteristic. Frequency characteristics can be adjusted by changing the magnitude of the capacitance value of the capacitive element 7123. When the capacitance value of the capacitive element 7123 is increased, the frequency (cutoff frequency) at which attenuation starts as viewed from the low frequency side can be lowered. In this manner, with the function of adjusting the frequency characteristics, the frequency characteristics can be adjusted in accordance with the characteristics of the noise component of the pixel power supply via the pixel 20.

Furthermore, the high-frequency correction circuit 72 illustrated in FIG. 7 also has a function of adjusting frequency characteristics. This adjustment of the frequency characteristics can be performed by adjusting the resistance value of the resistive element 7141 including the variable resistive element of the high-pass filter 714. The noise component via the reference signal generation unit 60 gradually decreases as viewed from the high frequency side in a region where the frequency is equal to or less than a certain value. The attenuation characteristic of the second correction signal needs to be adjusted according to the characteristic. When the resistance value of the resistive element 7141 is increased, the frequency (cutoff frequency) at which attenuation starts as viewed from the high frequency side can be lowered. In this manner, with the function of adjusting the frequency characteristics, the frequency characteristics can be adjusted in accordance with the characteristics of the noise component of the pixel power supply via the reference signal generation unit 60.

Gain adjustment and frequency characteristic adjustment in the low-frequency correction circuit 71 and the high-frequency correction circuit 72 are performed at a design stage and a chip evaluation stage.

### 2-2. Example 2

Example 2 in the embodiment of the present technology is an example of removing power supply noise of the comparator 52. The noise correction circuit 70 is the same as that of Example 1 in that it includes two correction circuits of a low-frequency correction circuit 71 and a high-frequency correction circuit 72.

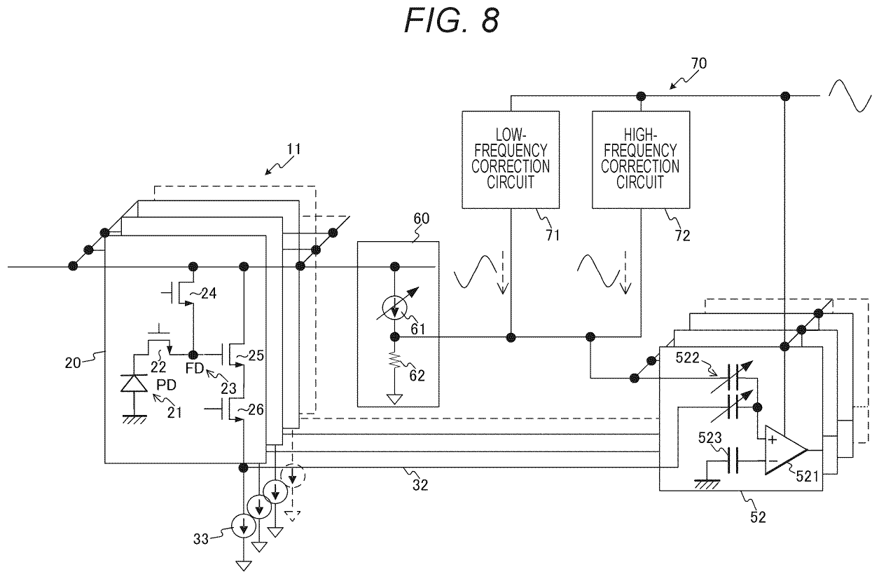

FIG. 8 is a circuit diagram illustrating a configuration example of the noise correction circuit 70 according to Example 2 in the embodiment of the present technology. FIG. 8 also illustrates a circuit unit related to the noise correction circuit 70, that is, the pixel array unit 11, the reference signal generation unit 60, and the comparator 52.

In Example 1, the low-frequency correction circuit 71 and the high-frequency correction circuit 72 use the same power supply as the pixel 20 as the operation power supply. On the other hand, in Example 2, the low-frequency correction circuit 71 and the high-frequency correction circuit 72 use the same power supply as the comparator 52 as the operation power supply, and output a current according to the variation of the power supply.

The output terminals of the low-frequency correction circuit 71 and the high-frequency correction circuit 72 are connected to the output terminal of the reference signal generation unit 60, that is, the output terminal that outputs the reference signal RAMP of the ramp wave. The currents output from the low-frequency correction circuit 71 and the high-frequency correction circuit 72 flow into the resistive element 62 of the reference signal generation unit 60 to be converted into voltage signals.

The comparator 52 including the input capacitance switching unit 522 may be greatly affected by power supply noise of the comparator 52. If the power supply voltage supplied to the comparator 52 varies at the timing when the output of the comparator 52 is inverted depending on the signal level of the pixel 20, an error may occur in the comparison and determination result. In order to eliminate the influence, the noise correction circuit 70 according to Example 2 includes a low-frequency correction circuit 71 and a high-frequency correction circuit 72 using the same power supply as the comparator 52 as an operation power supply.

An appropriate output phase of the correction signal (cancel signal) for eliminating the influence of the power supply noise of the comparator 52 may be different between a relatively low frequency band and a relatively high frequency band. Therefore, similarly to the case of Example 1, the first correction signal output from the low-frequency correction circuit 71 and the second correction signal output from the high-frequency correction circuit 72 are configured to have different phases.

The circuit configurations of the low-frequency correction circuit 71 and the high-frequency correction circuit 72 in the noise correction circuit 70 according to Example 2 are the same as the circuit configurations of the low-frequency correction circuit 71 and the high-frequency correction circuit 72 in the noise correction circuit 70 according to Example 1.

According to the noise correction circuit 70 of Example 2 described above, the power supply noise of the comparator 52 can be corrected and preferably canceled by superimposing, on the reference signal RAMP, the first correction signal and the second correction signal generated by the low-frequency correction circuit 71 and the high-frequency correction circuit 72 using the same power supply as the comparator 52 as the operation power supply. Therefore, it is possible to prevent an error caused by the power supply noise of the comparator 52 from occurring in the comparison and determination result of the comparator 52.

### 2-3. Example 3

Example 3 in the embodiment of the present technology is a modification of Example 1, and is an example in which each of the low-frequency correction circuit 71 and the high-frequency correction circuit 72 includes a pair of correction circuits.

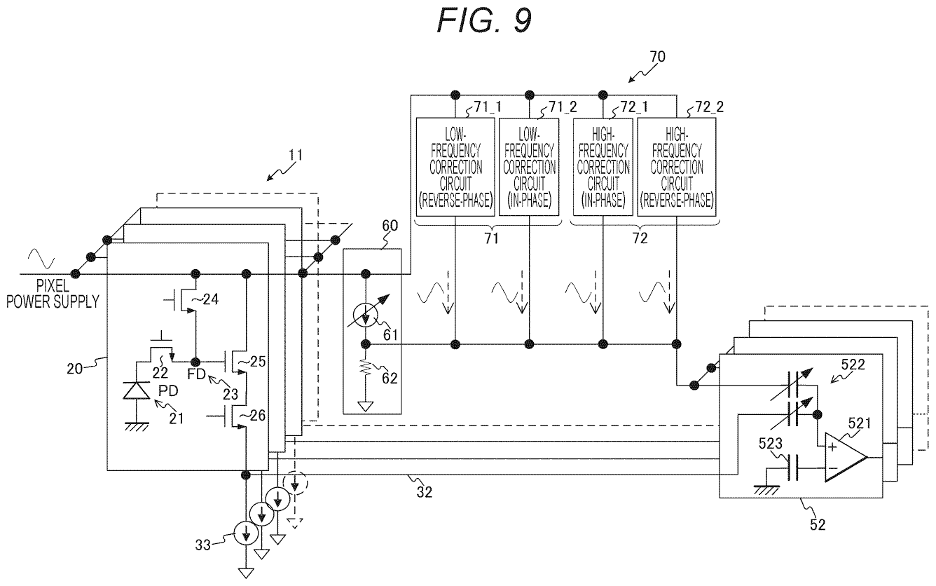

FIG. 9 is a circuit diagram illustrating a configuration example of the noise correction circuit 70 according to Example 3 in the embodiment of the present technology. FIG. 9 also illustrates a circuit unit related to the noise correction circuit 70, that is, the pixel array unit 11, the reference signal generation unit 60, and the comparator 52.

As illustrated in FIG. 9, in the noise correction circuit 70 according to Example 3, the low-frequency correction circuit 71 includes a reverse-phase correction circuit 71_1 and an in-phase correction circuit 71_2 as a pair of correction circuits, and the high-frequency correction circuit 72 includes an in-phase correction circuit 72_1 and a reverse-phase correction circuit 72_2 as a pair of correction circuits.

In the low-frequency correction circuit 71, similarly to the low-frequency correction circuit 71 in Example 1, the reverse-phase correction circuit 71_1 generates a reverse-phase correction signal for the variation component of the pixel power supply, and the in-phase correction circuit 71_2 generates an in-phase correction signal for the variation component of the pixel power supply. That is, the reverse-phase correction circuit 71_1 and the in-phase correction circuit 71_2 generate a pair of correction signals whose phases are inverted from each other.

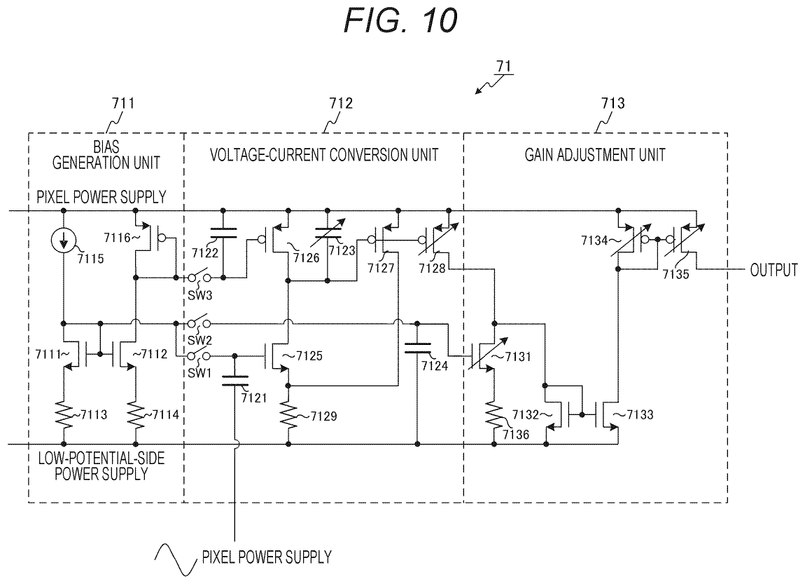

The circuit configuration of the reverse-phase correction circuit 71_1 can be the circuit configuration of the low-frequency correction circuit 71 illustrated in FIG. 6 because the reverse-phase correction signal is generated with respect to the variation of the pixel power supply. The circuit configuration of the in-phase correction circuit 71_2 can be the circuit configuration illustrated in FIG. 10. As illustrated in FIG. 10, the gain adjustment unit 713 of the in-phase correction circuit 71_2 has the same circuit configuration as the gain adjustment unit 713 in the high-frequency correction circuit 72 illustrated in FIG. 7, so that it is possible to generate the in-phase correction signal for the variation component of the pixel power supply.

In the high-frequency correction circuit 72, similarly to the high-frequency correction circuit 72 in Example 1, the in-phase correction circuit 72_1 generates an in-phase correction signal for the variation component of the pixel power supply, and the reverse-phase correction circuit 72_2 generates a reverse-phase correction signal for the variation component of the pixel power supply. That is, the in-phase correction circuit 72_1 and the reverse-phase correction circuit 72_2 generate a pair of correction signals whose phases are inverted from each other.

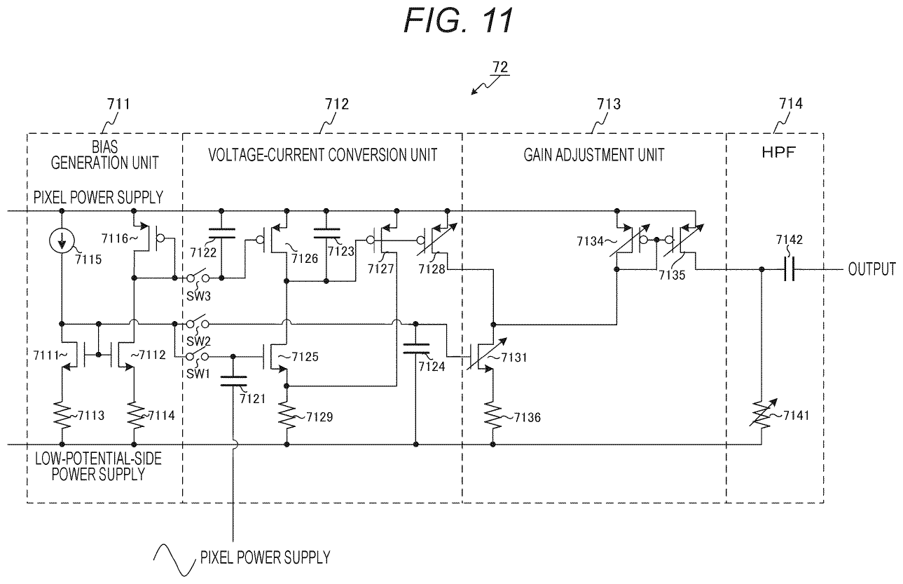

The circuit configuration of the in-phase correction circuit 72_1 can be the circuit configuration of the high-frequency correction circuit 72 illustrated in FIG. 7 because the in-phase correction signal is generated with respect to the variation of the pixel power supply. The circuit configuration of the reverse-phase correction circuit 72_2 can be the circuit configuration illustrated in FIG. 11. As illustrated in FIG. 11, for the gain adjustment unit 713 of the reverse-phase correction circuit 72 2, the drain electrode of the nMOS transistor 7131 and the drain electrode of the pMOS transistor 7134 are electrically connected, so that it is possible to generate a reverse-phase correction signal for the variation component of the pixel power supply.

In Example 1, it has been assumed that the influence of the in-phase component of the power supply noise having passed through the pixel 20 is large, and the power supply noise is corrected by generating the reverse-phase correction signal with respect to the power supply noise using the low-frequency correction circuit 71. However, in practice, it may not be said that the influence of the in-phase component of the power supply noise is large. In such a case, the reverse-phase correction circuit 71_1 and the in-phase correction circuit 71_2 are used together in the relatively low frequency band. Therefore, even in a case where the influence of the in-phase component of the power supply noise cannot be said to be large, the power supply noise can be corrected.

Similarly, in Example 1, the high-frequency correction circuit 72 generates the in-phase correction signal with respect to the power supply noise to correct the power supply noise, but in practice, there is a case where the influence of the power supply noise having a phase different from the assumed phase occurs. In such a case, the in-phase correction circuit 72_1 and the reverse-phase correction circuit 72_2 are used together in a relatively high frequency band. Therefore, the power supply noise can be corrected even in a case where the influence of the power supply noise having a phase different from the assumed phase occurs.

In recent years, the circuit configuration of the pixel 20 and the reference signal generation unit 60 tends to be complicated, and the influence of power supply noise is also complicated. Even under such a situation, according to the noise correction circuit 70 of Example 3, each of the low-frequency correction circuit 71 and the high-frequency correction circuit 72 includes the pair of correction circuits that selectively generate the pair of in-phase and reverse-phase correction signals, so that even if the circuit configuration of the pixel 20 and the reference signal generation unit 60 tends to be complicated, it is possible to easily cope with the influence of the complicated noise.

### 2-4. Example 4

Example 4 in the embodiment of the present technology is a modification of Example 3, and is a circuit configuration example in which the correction signals generated by the low-frequency correction circuit 71 and the high-frequency correction circuit 72 can be switched between in-phase and reverse-phase in each correction circuit.

The in-phase/reverse-phase switching of the correction signal is executed by the gain adjustment unit 713 in the low-frequency correction circuit 71 and the high-frequency correction circuit 72. That is, each gain adjustment unit 713 of the low-frequency correction circuit 71 and the high-frequency correction circuit 72 has a function capable of switching between in-phase and reverse-phase correction signals to be generated.

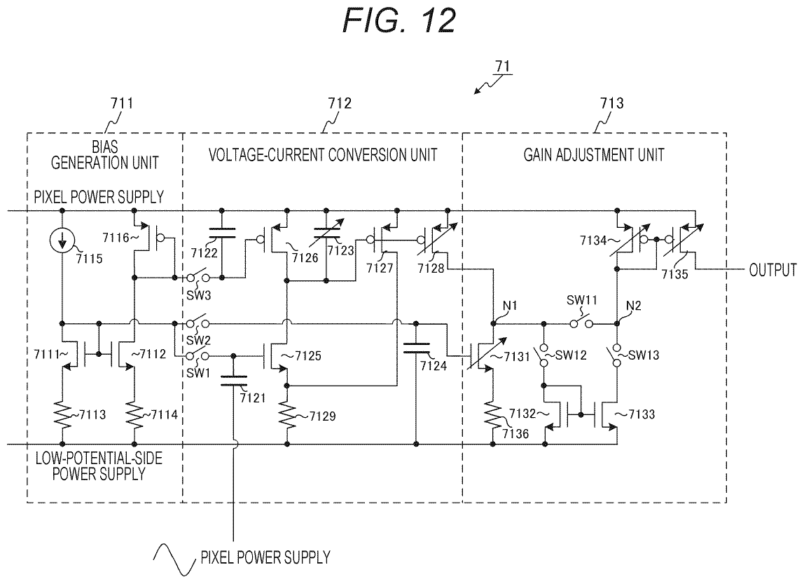

FIG. 12 is a circuit diagram illustrating a circuit example of the low-frequency correction circuit 71 in the noise correction circuit 70 according to Example 4.

In the noise correction circuit 70 according to Example 4, the gain adjustment unit 713 in the low-frequency correction circuit 71 can select in-phase or reverse-phase for the phase of the correction signal to be generated.

Specifically, as illustrated in FIG. 12, the gain adjustment unit 713 in the low-frequency correction circuit 71 includes three switch elements SW11 to SW13. The switch element SW11 is connected between a node N1 to which the drain electrodes of the pMOS transistor 7128 and the nMOS transistor 7131 are connected in common and a node N2 to which the drain electrode of the pMOS transistor 7134 is connected. The switch element SW12 is connected between the node N1 and the drain electrode of the nMOS transistor 7132. The switch element SW13 is connected between the node N2 and the drain electrode of the nMOS transistor 7133.

In the gain adjustment unit 713 of the low-frequency correction circuit 71 having the above-described configuration, when the switch elements SW12 and SW13 are turned off (open) and only the switch element SW11 is turned on (closed), the circuit configuration is electrically the same as the circuit configuration illustrated in FIG. 10. At this time, an in-phase correction signal can be generated for the variation component of the pixel power supply. Furthermore, when the switch element SW11 is turned off and both the switch elements SW12 and SW13 are turned on, the circuit configuration is electrically the same as that illustrated in FIG. 6. At this time, it is possible to generate a reverse-phase correction signal for the variation component of the pixel power supply.

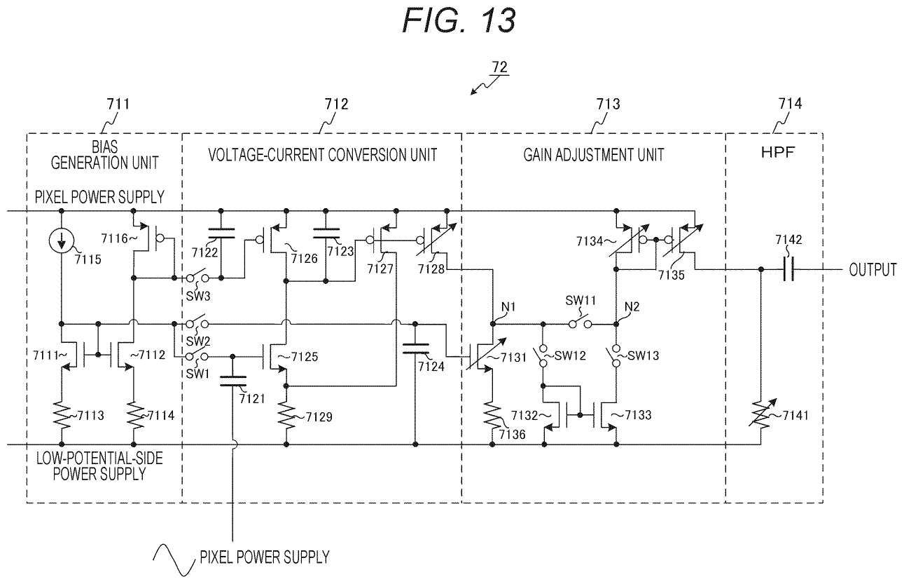

FIG. 13 is a circuit diagram illustrating a circuit example of the high-frequency correction circuit 72 in the noise correction circuit 70 according to Example 4.

In the noise correction circuit 70 according to Example 4, the gain adjustment unit 713 in the high-frequency correction circuit 72 can select in-phase or reverse-phase for the phase of the correction signal to be generated.

Specifically, the gain adjustment unit 713 in the high-frequency correction circuit 72 has a circuit configuration similar to that of the gain adjustment unit 713 in the low-frequency correction circuit 71. That is, as illustrated in FIG. 13, the gain adjustment unit 713 in the high-frequency correction circuit 72 includes three switch elements SW11 to SW13. The switch element SW11 is connected between the node N1 and the node N2. The switch element SW12 is connected between the node N1 and the drain electrode of the nMOS transistor 7132. The switch element SW13 is connected between the node N2 and the drain electrode of the nMOS transistor 7133.

In the gain adjustment unit 713 of the high-frequency correction circuit 72 having the above-described configuration, when the switch elements SW12 and SW13 are turned off and only the switch element SW11 is turned on, the circuit configuration is electrically the same as the circuit configuration illustrated in FIG. 11. At this time, it is possible to generate a reverse-phase correction signal for the variation component of the pixel power supply. Furthermore, when the switch element SW11 is turned off and both the switch elements SW12 and SW13 are turned on, the circuit configuration is electrically the same as that illustrated in FIG. 7. At this time, an in-phase correction signal can be generated for the variation component of the pixel power supply.

In the noise correction circuit 70 according to Example 3, in order to selectively generate a pair of in-phase and reverse-phase correction signals, each of the low-frequency correction circuit 71 and the high-frequency correction circuit 72 includes the pair of correction circuits. On the other hand, according to the noise correction circuit 70 of Example 4, it is possible to realize a function of switching the in-phase and the reverse-phase of the correction signal only by the on/off control of the switch elements SW11, SW12, and SW13 in one circuit (the low-frequency correction circuit 71/the high-frequency correction circuit 72). Therefore, even if the circuit configuration of the pixel 20 and the reference signal generation unit 60 tends to be complicated, it is possible to easily cope with the influence of the complicated noise only by the on/off control of the switch elements SW11, SW12, and SW13 in one circuit (each of the low-frequency correction circuit 71 and the high-frequency correction circuit 72).

### 3. Another Circuit Example of Comparator in Analog-Digital Conversion Unit

In the above-described embodiment, the case of using the ultra-low voltage comparator having the input capacitance switching unit 522 as the comparator 52 in the analog-digital conversion unit 50 has been described as an example, but the present technology is not limited to the case of using the ultra-low voltage comparator. Hereinafter, other circuit examples of the comparator that can be used other than the ultra-low voltage comparator will be exemplified as Circuit Example 1 and Circuit Example 2.

### 3-1. Circuit Example 1

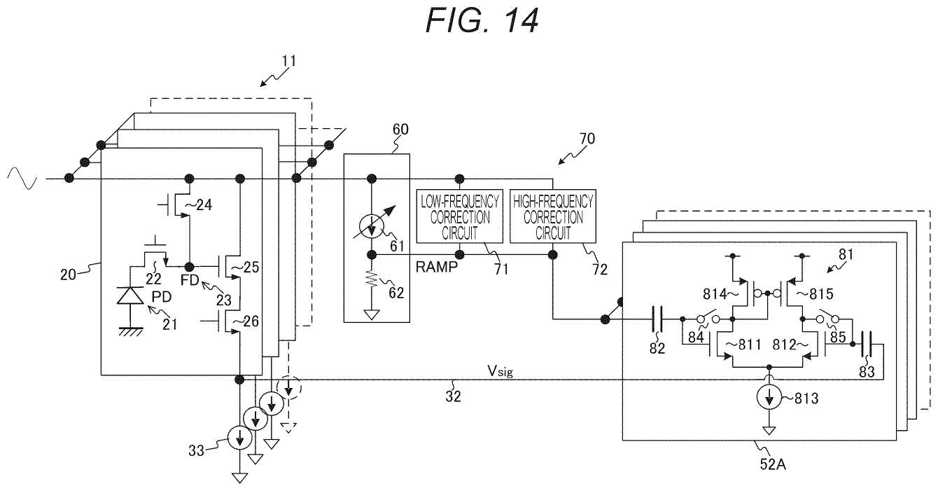

FIG. 14 is a circuit diagram illustrating a circuit configuration example of a comparator 52A according to Circuit Example 1.

As illustrated in FIG. 14, the comparator 52A according to Circuit Example 1 includes a differential amplifier 81, a first capacitive element 82, a second capacitive element 83, a first switch element 84, and a second switch element 85. The differential amplifier 81 includes nMOS transistors 811 and 812, a current source 813, and pMOS transistor 814 and 815.

In the differential amplifier 81, the nMOS transistor 811 and the nMOS transistor 812 form a differential pair in which source electrodes are connected in common to perform differential operation. The current source 813 is connected between the source common connection node of the nMOS transistor 811 and the nMOS transistor 812 and the reference potential node. The pMOS transistor 814 has a diode-connected configuration in which a gate electrode and a drain electrode are connected in common, and is connected in series to the nMOS transistor 811. That is, the drain electrodes of the pMOS transistor 814 and the nMOS transistor 811 are commonly connected.

The pMOS transistor 815 is connected in series to the nMOS transistor 812. That is, the drain electrodes of the pMOS transistor 815 and the nMOS transistor 812 are commonly connected. Then, the pMOS transistor 814 and the pMOS transistor 815 have gate electrodes connected in common to constitute a current mirror circuit.

One end of the first capacitive element 82 is connected to the output terminal of the reference signal generation unit 60, and the other end is connected to the gate electrode of the nMOS transistor 811. Therefore, the reference signal RAMP generated by the reference signal generation unit 60 is provided to the gate electrode of the nMOS transistor 811 via the first capacitive element 82.

One end of the second capacitive element 83 is connected to the signal line 32 for transmitting a signal from the pixel 20, and the other end is connected to the gate electrode of the nMOS transistor 812. Therefore, the pixel signal Vsig output from the pixel 20 is provided to the gate electrode of the nMOS transistor 812 via the signal line 32 and the second capacitive element 83.

The first switch element 84 is connected between the gate electrode and the drain electrode of the nMOS transistor 811, and the on/off control is performed by a predetermined control signal. The second switch element 85 is connected between the gate electrode and the drain electrode of the nMOS transistor 812, and the on/off control is performed by a predetermined control signal.

The comparator 52A according to Circuit Example 1 having the above-described configuration can also be used as the comparator 52 of the analog-digital conversion unit 50 in the embodiment of the present technology.

### 3-2. Circuit Example 2

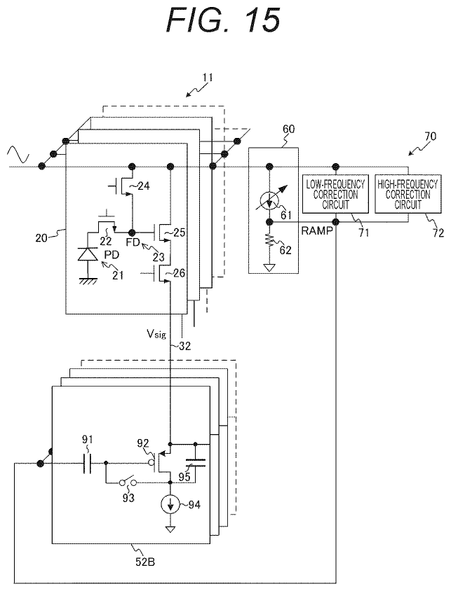

FIG. 15 is a circuit diagram illustrating a circuit configuration example of a comparator 52B according to Circuit Example 2.

As illustrated in FIG. 15, the comparator 52B according to Circuit Example 2 includes a first capacitive element 91, a pMOS transistor 92, a switch element 93, a current source 94, and a second capacitive element 95.

One end of the first capacitive element 91 is connected to the output terminal of the reference signal generation unit 60, and the other end is connected to the gate electrode of the pMOS transistor 92. Therefore, the reference signal RAMP generated by the reference signal generation unit 60 is provided to the gate electrode of the pMOS transistor 92 via the first capacitive element 91.

A source electrode of the pMOS transistor 92 is connected to the signal line 32 that transmits a signal from the pixel 20. Therefore, the pixel signal Vsig output from the pixel 20 is provided to the source electrode of the pMOS transistor 92 via the signal line 32.

The switch element 93 is connected between the gate electrode and the drain electrode of the pMOS transistor 92, and the on/off control is performed by a predetermined control signal.

The current source 94 is connected between the drain electrode of the pMOS transistor 92 and the reference potential node. The second capacitive element 95 is connected between the source electrode and the drain electrode of the pMOS transistor 92, that is, in parallel with the pMOS transistor 92.

The comparator 52B according to Circuit Example 2 having the above-described configuration can also be used as the comparator 52 of the analog-digital conversion unit 50 in the embodiment of the present technology.

### 4. Modifications

Note that the above-described embodiments describe an example for embodying the present technology, and there is a correspondence relationship between the matters in the embodiments and the matters specifying the invention in claims. Similarly, there is a correspondence relationship between the matters specifying the invention in claims and the matters in the embodiments of the present technology having the same names. However, the present technology is not limited to the embodiments, and can be embodied by applying various modifications to the embodiments without departing from the scope of the present technology.

### 5. Application Example to Electronic Apparatus

The imaging element according to the embodiments of the present technology described above is applicable to various electronic apparatuses having an imaging function such as an imaging device such as a digital still camera or a video camera, a mobile terminal device having an imaging function such as a mobile phone, and a copier using an imaging device in an image reading unit.

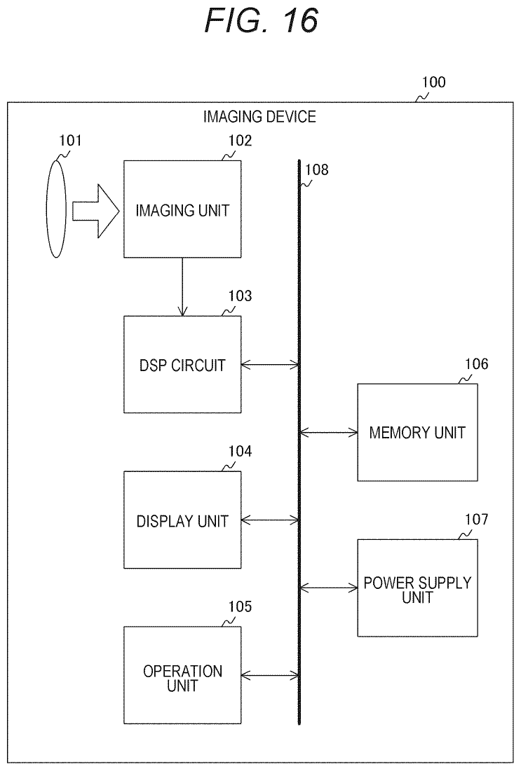

Example of Imaging Device FIG. 16 is a block diagram illustrating a configuration example of an imaging device which is an example of an electronic apparatus to which the present technology is applied.

An imaging device 100 according to the present application example is a device for imaging a subject, and includes an imaging optical system 101 including a lens group and the like, an imaging unit 102, a digital signal processor (DSP) circuit 103, a display unit 104, an operation unit 105, a memory unit 106, and a power supply unit 107. These are connected to one another by a bus 108. As the imaging device 100, for example, in addition to a digital camera such as a digital still camera, a smartphone and a personal computer having an imaging function, an in-vehicle camera, and the like are assumed.

The imaging unit 102 generates pixel data by photoelectric conversion. As the imaging unit 102, the imaging element according to the embodiment of the present technology can be used. Light from a subject is condensed and guided to a light receiving surface of the imaging unit 102 by the imaging optical system 101 arranged on an incident light side. The imaging unit 102 supplies pixel data generated by photoelectric conversion to the DSP circuit 103 in the subsequent stage.

The DSP circuit 103 executes predetermined signal processing on the pixel data from the imaging unit 102. The display unit 104 displays the pixel data. As the display unit 104, for example, a liquid crystal panel or an organic electro luminescence (EL) panel is assumed. The operation unit 105 generates an operation signal according to a user's operation. The memory unit 106 stores various types of data such as the pixel data. The power supply unit 107 supplies power to the imaging unit 102, the DSP circuit 103, the display unit 104, and the like.

In the imaging device 100 having the above configuration, by using the imaging element according to the embodiment of the present technology as the imaging unit 102, it is possible to correct, preferably cancel, the noise of the pixel power supply not only in the relatively low frequency band but also in the relatively high frequency band, and thus, it is possible to obtain a captured image with higher image quality.

6. Example of application of Embodiments of Present Technology

The above embodiments of the present technology can be applied to various technologies as exemplified below.

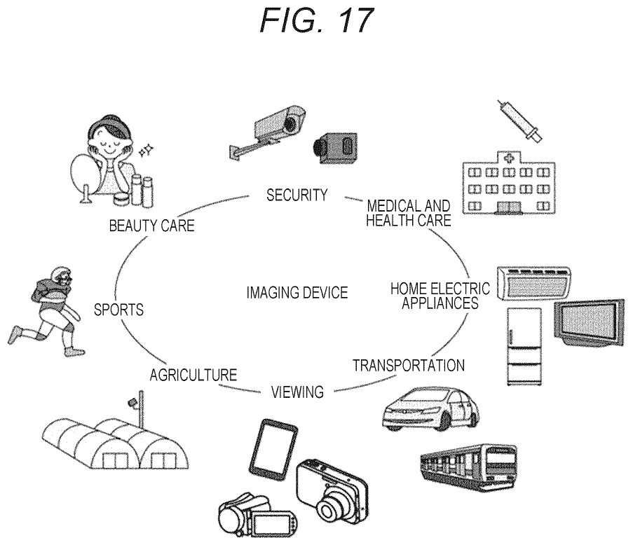

FIG. 17 illustrates an example of fields to which the embodiments of the present technology are applied.

The imaging device according to the embodiments of the present technology can be, for example, used as a device that captures an image to be used for viewing, such as a digital camera or a portable device having a camera function.

Furthermore, this imaging device can be used as a device for traffic purpose such as an in-vehicle sensor which takes an image of surroundings, interior, or the like of an automobile, a surveillance camera for monitoring traveling vehicles and roads, and a ranging sensor which measures a distance between vehicles and the like for safe driving such as automatic stop, recognition of a driver's condition and the like.

Furthermore, this imaging device can be used as a device used for home electric appliances such as a television, a refrigerator, and an air conditioner in order to capture an image of a gesture of a user and perform device operation according to the gesture.

Furthermore, this imaging device can be used as a device for medical and health care use such as an endoscope and a device that performs angiography by receiving infrared light.

Furthermore, this imaging device can be used as a device for security use such as a security monitoring camera and an individual authentication camera.

Furthermore, this imaging device can be used as a device used for beauty care, such as a skin measuring instrument for imaging skin, and a microscope for imaging the scalp.

Furthermore, this imaging device can be used as a device used for sport, such as an action camera or a wearable camera for sports applications or the like.

Furthermore, this imaging device can be used as a device used for agriculture, such as a camera for monitoring a condition of a field or crop.

### 7. Application Example to Mobile Body

The technology (the present technology) according to the present disclosure can be applied to various products. For example, the technology of the present disclosure may be implemented as a device mounted on any type of mobile body such as an automobile, an electric vehicle, a hybrid electric vehicle, a motorcycle, a bicycle, a personal mobility, an airplane, a drone, a ship, a robot, and the like.

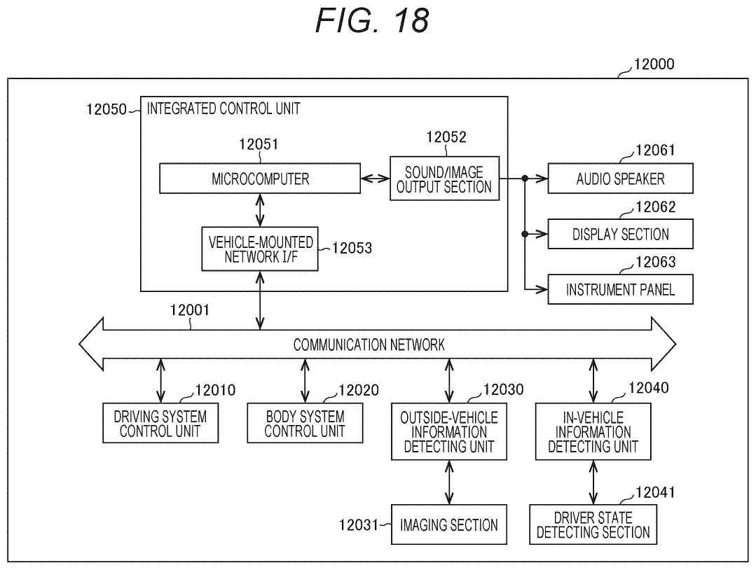

FIG. 18 is a block diagram illustrating a schematic configuration example of a vehicle control system as an example of a mobile body control system to which the technology according to the present disclosure can be applied.

The vehicle control system 12000 includes a plurality of electronic control units connected to each other via a communication network 12001. In the example illustrated in FIG. 18, the vehicle control system 12000 includes a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

Furthermore, the microcomputer 12051 can output a control command to the body system control unit 12020 on the basis of the information about the outside of the vehicle obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 18, an audio speaker 12061, a display section 12062, and an instrument panel 12063 are exemplified as the output devices. The display section 12062 may, for example, include at least one of an on-board display and a head-up display.

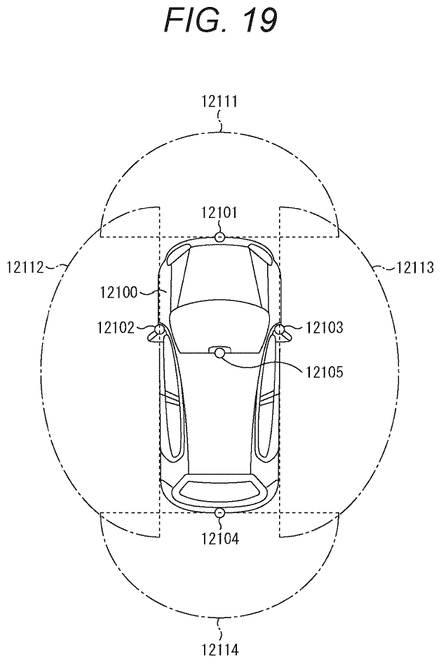

FIG. 19 is a view illustrating an example of an installation position of the imaging section 12031.

In FIG. 19, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within an interior of the vehicle, and the like. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 19 depicts an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology of the present disclosure can be applied has been described above. The technology according to the present disclosure can be applied to, for example, the imaging section 12031 among the configurations described above. Specifically, the imaging element 10 in FIG. 1 including the noise correction circuit in the embodiment of the technology according to the present disclosure can be applied to the imaging section 12031. By applying the technology according to the present disclosure to the imaging section 12031, it is possible to correct, preferably cancel, the noise of the pixel power supply not only in a relatively low frequency band but also in a relatively high frequency band, and to obtain a captured image with higher image quality. Therefore, it is possible to reduce driver's fatigue.

Note that advantageous effects described in the present description are merely examples and are not limited, and other advantageous effects may be provided.

7. Configuration that can be Taken by Present Technology

Note that the present technology may also have the following configurations.

(1) An imaging element including:
a pixel that outputs a pixel signal according to incident light;
a reference signal generation unit that generates a reference signal having an inclined waveform, the inclined waveform linearly changing with a predetermined inclination as time elapses;
an analog-digital conversion circuit that includes a comparator, the comparator comparing the pixel signal with the reference signal, and performs analog-digital conversion on the pixel signal; and
a noise correction circuit that corrects noise of a pixel power supply, the pixel power supply supplying power to the pixel by superimposing the noise on the reference signal, in which
the noise correction circuit includes:
a first correction circuit that generates a first correction signal for correcting a relatively low frequency band with respect to noise of the pixel power supply; and
a second correction circuit that generates a second correction signal, the second correction signal being different in output polarity from the first correction signal and correcting a relatively high frequency band for noise of the pixel power supply.

(2) The imaging element according to (1), in which
the first correction circuit generates a reverse-phase signal for a variation component of the pixel power supply as the first correction signal, and
the second correction circuit generates an in-phase signal for a variation component of the pixel power supply as the second correction signal.

(3) The imaging element according to (1) or (2), in which
the first correction circuit and the second correction circuit each have a function of adjusting frequency characteristics of the first correction signal and the second correction signal.

(4) The imaging element according to (1), in which
the noise correction circuit corrects noise of a power supply that supplies power to the comparator.

(5) The imaging element according to (1) or (2), in which
the first correction circuit generates a pair of signals having phases inverted from each other as the first correction signal, and
the second correction circuit generates a pair of signals having phases inverted from each other as the second correction signal.

(6) The imaging element according to (5), in which
the first correction circuit and the second correction circuit each include a pair of correction circuits that generate a pair of signals having phases inverted from each other.

(7) The imaging element according to (5), in which
the first correction circuit and the second correction circuit each generate a pair of signals having phases inverted from each other by on/off control of a switch element.

(8) An electronic apparatus including:
an imaging element, in which
the imaging element includes:
a pixel that outputs a pixel signal according to incident light;
a reference signal generation unit that generates a reference signal having an inclined waveform, the inclined waveform linearly changing with a predetermined inclination as time elapses;
an analog-digital conversion circuit that includes a comparator, the comparator comparing the pixel signal with the reference signal, and performs analog-digital conversion on the pixel signal; and
a noise correction circuit that corrects noise of a pixel power supply, the pixel power supply supplying power to the pixel by superimposing the noise on the reference signal, and
the noise correction circuit includes:
a first correction circuit that outputs a first correction signal for correcting a relatively low frequency band with respect to noise of the pixel power supply; and
a second correction circuit that outputs a second correction signal, the second correction signal being different in output polarity from the first correction signal and correcting a relatively high frequency band for noise of the pixel power supply.

### REFERENCE SIGNS LIST

10 Imaging element
11 Pixel array unit
12 Vertical scanning unit
13 Column processing unit
14 Horizontal scanning unit
15 Digital signal calculation unit
16 Timing control unit
20 Pixel (pixel circuit)
21 Photoelectric conversion unit
22 Charge transfer unit
23 Charge-voltage conversion unit
24 Charge resetting signal
25 Signal amplification unit
26 Pixel selection unit
31 Pixel control line
32 Signal line
33 Constant current source
50 Analog-digital conversion unit
51 Analog-digital conversion circuit
52, 52A, 52B Comparator
53 Column counter
60 Reference signal generation unit
70 Noise correction circuit
71 (71_1, 71_2) Low-frequency correction circuit
72 (72_1, 72_2) High-frequency correction circuit
711 Bias generation unit
712 Voltage-current conversion circuit
713 Gain adjustment unit
714 High-pass filter (HPF)
SW1 to SW3, SW11 to SW13 Switch element

1. An imaging element comprising:
a pixel that outputs a pixel signal according to incident light;
a reference signal generation unit that generates a reference signal having an inclined waveform, the inclined waveform linearly changing with a predetermined inclination as time elapses;
an analog-digital conversion circuit that includes a comparator, the comparator comparing the pixel signal with the reference signal, and performs analog-digital conversion on the pixel signal; and
a noise correction circuit that corrects noise of a pixel power supply, the pixel power supply supplying power to the pixel by superimposing the noise on the reference signal, wherein
the noise correction circuit includes:
a first correction circuit that generates a first correction signal for correcting a relatively low frequency band with respect to noise of the pixel power supply; and
a second correction circuit that generates a second correction signal, the second correction signal being different in output polarity from the first correction signal and correcting a relatively high frequency band for noise of the pixel power supply.

2. The imaging element according to claim 1, wherein
the first correction circuit generates a reverse-phase signal for a variation component of the pixel power supply as the first correction signal, and
the second correction circuit generates an in-phase signal for a variation component of the pixel power supply as the second correction signal.

3. The imaging element according to claim 1, wherein
the first correction circuit and the second correction circuit each have a function of adjusting frequency characteristics of the first correction signal and the second correction signal.

4. The imaging element according to claim 1, wherein
the noise correction circuit corrects noise of a power supply that supplies power to the comparator.

5. The imaging element according to claim 1, wherein
the first correction circuit generates a pair of signals having phases inverted from each other as the first correction signal, and
the second correction circuit generates a pair of signals having phases inverted from each other as the second correction signal.

6. The imaging element according to claim 5, wherein
the first correction circuit and the second correction circuit each include a pair of correction circuits that generate a pair of signals having phases inverted from each other.

7. The imaging element according to claim 5, wherein
the first correction circuit and the second correction circuit each generate a pair of signals having phases inverted from each other by on/off control of a switch element.

8. An electronic apparatus comprising:
an imaging element, wherein
the imaging element includes:
a pixel that outputs a pixel signal according to incident light;
a reference signal generation unit that generates a reference signal having an inclined waveform, the inclined waveform linearly changing with a predetermined inclination as time elapses;
an analog-digital conversion circuit that includes a comparator, the comparator comparing the pixel signal with the reference signal, and performs analog-digital conversion on the pixel signal; and
a noise correction circuit that corrects noise of a pixel power supply, the pixel power supply supplying power to the pixel by superimposing the noise on the reference signal, and
the noise correction circuit includes:
a first correction circuit that outputs a first correction signal for correcting a relatively low frequency band with respect to noise of the pixel power supply; and
a second correction circuit that outputs a second correction signal, the second correction signal being different in output polarity from the first correction signal and correcting a relatively high frequency band for noise of the pixel power supply.
